(19) United States
(12) Patent Application Publication
(10) Pub. No.: US 2010/0059021 A1
(43) Pub. Date: Mar. 11, 2010

(54) FUEL INJECTION SYSTEM AND METHOD FOR ASCERTAINING A NEEDLE STROKE STOP IN A FUEL INJECTOR

(75) Inventors: Andreas Rau, Stuttgart (DE); Oliver Becker, Schriessheim (DE); Erik Tonner, Gerlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/304,701

(22) PCT Filed: Nov. 23, 2007
(86) PCT No.: PCT/EP2007/062726

§ 371 Date: Aug. 26, 2009

(30) Foreign Application Priority Data
Dec. 14, 2006 (DE) 10 2006 059 070.8

(51) Int. Cl. F02M 51/00

(52) U.S. Cl. 123/478; 123/494

(57) ABSTRACT

In fuel injection system having at least one fuel injector and a control unit for triggering the injector, each injector has a piezoelectric actuator, a nozzle element having at least one nozzle opening and at least one movable nozzle needle for selectively closing and opening the at least one nozzle opening, a hydraulic coupling element, which is connected between the piezoelectric actuator and the nozzle needle, and at least one stroke stop, against which the nozzle needle rests in its completely open and/or completely closed position. To be better able to ascertain when the stroke stop is reached in such injectors, the needle stroke stop is ascertained during an energization pause of the piezoelectric actuator by analyzing a voltage signal applied to the piezoelectric actuator. Oscillations of the voltage signal during the energization pause are preferably analyzed. To this end, regression lines are drawn through the voltage characteristic, a correlation coefficient of the regression lines to the voltage characteristic is ascertained and a needle stroke stop is detected on the basis of the correlation coefficient.

### FIELD OF THE INVENTION

The present invention relates to a fuel injection system and a method for ascertaining a needle stroke stop in a fuel injector.

### BACKGROUND INFORMATION

Fuel injectors for injecting diesel or gasoline into the intake manifold or directly into the combustion chamber of an internal combustion engine are known from the related art. The injectors may be operated by piezoelectric actuators to meet high dynamic requirements. A hydraulic coupler is connected between the piezoelectric actuator and a nozzle needle of the injector for temperature equalization and for translation. With the known injectors of the CRI-PDN type (common rail injector-piezo direct needle) from Robert Bosch GmbH, the nozzle needle is set in motion more or less directly by the piezoelectric actuator, i.e., the movement of the nozzle needle follows the actuator stroke in a first approximation. The actuator stroke is in turn proportional to the trigger voltage in a first approximation at a constant actuator force.

The mechanical and electrical variables and relationships in the injector may change due to manufacturing tolerances and wear over the entire lifetime of a fuel injector and due to fluctuating operating temperatures. For example, the actuator stroke may decline with an increase in lifetime, so that the nozzle needle opens later and closes sooner, resulting in injection of less fuel than desired.

### SUMMARY

Example embodiments of the present invention detect that a stroke stop has been reached in the case of fuel injectors operated by piezoelectric actuators and in particular to ascertain the instant at which the stroke stop is reached.

Example embodiments of the present invention provide a fuel injection system in which the reaching of a stroke stop and/or the instant at which the stroke stop is reached may be ascertained in a particularly simple manner, i.e., in a manner that does not waste time and resources but is nevertheless highly accurate. Example embodiments of the present invention provide a method, which also allows particularly simple detection of the reaching of a stroke stop and/or the ascertaining of the instant at which the stroke stop is reached, i.e., in a manner that does not waste time and resources but is nevertheless highly accurate.

According to example embodiments of the present invention, the reaching of the stroke stop is ascertained by analyzing the voltage characteristic of the voltage applied to the piezoelectric actuator during a pause in energization. Oscillations in the voltage characteristic in particular that result when the nozzle needle is not in contact with a stroke stop should be evaluated and analyzed. The results of ascertaining this (stroke stop is not reached, stroke stop is reached later than estimated, stroke stop is not reached) may be taken into account in regulating the quantity of fuel to be injected. Therefore, it is possible to have a positive influence on the combustion of fuel in the combustion chamber of the internal combustion engine and combustion takes place quietly with low consumption and low exhaust.

This principle will now be explained in greater detail by the example of a directly coupled injector, the piezoelectric actuator being charged when the nozzle needle is closed (so-called inversely triggered injector). At the beginning, an initial voltage greater than 0 is applied to the piezoelectric actuator and the needle stroke is 0 μm (valve closed). To trigger an injection, the piezoelectric actuator is discharged, i.e., acted upon by a discharge current, so that the applied voltage drops (start of the discharge operation). The nozzle needle is lifted up from the valve seat with a time lag at the start of the discharge operation and partially releases the at least one nozzle opening. Shortly before reaching the stroke stop, the energization of the actuator ends and the actuator is disconnected (end of the discharge operation). At this instant, the voltage has reached its lowest level. Since the nozzle needle has not yet reached the stroke stop at this instant, it moves further in the previous direction due to inertia, so that the pressure in the coupling space of the hydraulic coupler increases again. Because of the piezoelectric effect, this ensures an increase in the actuator terminal voltage (so-called rising range). As soon as the nozzle needle has reached the stroke stop, the pressure in the coupling space no longer changes, so that the voltage remains almost constant (so-called plateau range). The break in the voltage between the rising range and the plateau range and/or the voltage peaks after the lowest level is reached at the end of the discharge operation thus correlate with the time at which the needle stroke stop of the valve seat is reached.

A corresponding effect also occurs in the opposite direction, i.e., when the injector is moved from the open position to the closed position. In the open position of the valve, the piezoelectric actuator is discharged and a relatively low initial voltage is applied. To terminate an injection, the piezoelectric actuator is activated again, i.e., is acted upon by a charging current, so that the applied voltage rises (start of the charging operation). With a time lag at the start of the charging operation, the nozzle needle drops in the direction of the valve seat, which functions as a stroke stop. Before reaching the valve seat, the energization of the actuator may be terminated and the actuator disconnected (end of the charging operation). At this instant, the voltage has reached its highest value. Because of inertia, the nozzle needle continues to move after the end of energization, so that the pressure in the coupling space of the hydraulic coupler drops. Because of the piezoelectric effect, this ensures a drop in the actuator terminal voltage (negative rising range). As soon as the nozzle needle is in tight contact with the stroke stop, the pressure in the coupling space and thus also the actuator voltage remain almost constant (so-called plateau range). The break in the voltage between the descending range and the plateau range and the voltage minimums after reaching the highest level at the end of the charging operation thus correlate with the time at which the needle stroke stop (of the valve seat) is reached.

Example embodiments allow exact, time-based determination of the break or of the voltage peak in the proposed manner, even when there is measurement noise or pressure-dependent dynamic effects within the injector, which may result in extreme rounding of the voltage characteristic, for example.

Example embodiments of the present invention are explained in greater detail below on the basis of the figures.

### BRIEF DESCRIPTION OF THE DRAWINGS

FIG. 1 shows a schematic view of a fuel injection system according to example embodiments of the present invention, including a fuel injector having a piezoelectric actuator and a control unit;

FIG. 2 shows a voltage and current characteristic of a fuel injection system, e.g., of the fuel injection system according to FIG. 1, to illustrate a first embodiment of the method according to example embodiments of the present invention;

FIG. 3 shows a voltage and current characteristic of a fuel injector, e.g., of the fuel injection system according to FIG. 1, to illustrate an example embodiment of the method according to the present invention;

FIG. 4 shows a voltage and current characteristic of a fuel injector, e.g., of the fuel injection system according to FIG. 1, to illustrate an example embodiment of the method according to the present invention;

FIG. 5 shows a voltage characteristic and a needle stroke characteristic of a fuel injector, e.g., of the fuel injection system according to FIG. 1, to illustrate an example embodiment of the method according to the present invention;

FIG. 6 shows a detail of the voltage characteristic and the needle stroke characteristic from FIG. 5 to illustrate an example embodiment of the method according to the present invention;

FIG. 7 shows a voltage characteristic and a needle stroke characteristic of a fuel injector, e.g., of the fuel injection system according to FIG. 1, to illustrate an example embodiment of the method according to the present invention;

FIG. 8 shows two voltage and current characteristics of different fuel injectors to illustrate an example embodiment of the method according to the present invention, one of the fuel injectors reaching a stroke stop and the other not reaching it;

FIG. 9 shows four different voltage and current characteristics to illustrate an example embodiment of the method according to the present invention;

FIG. 10 shows a supplemented regulator structure having a sum of the squares of the deviations of a regression line to the characteristic of the actuator voltage as a criterion for stroke stop detection; and

FIG. 11 shows the function of the response of the regulator structure from FIG. 10 to not reaching a stroke stop.

### DETAILED DESCRIPTION

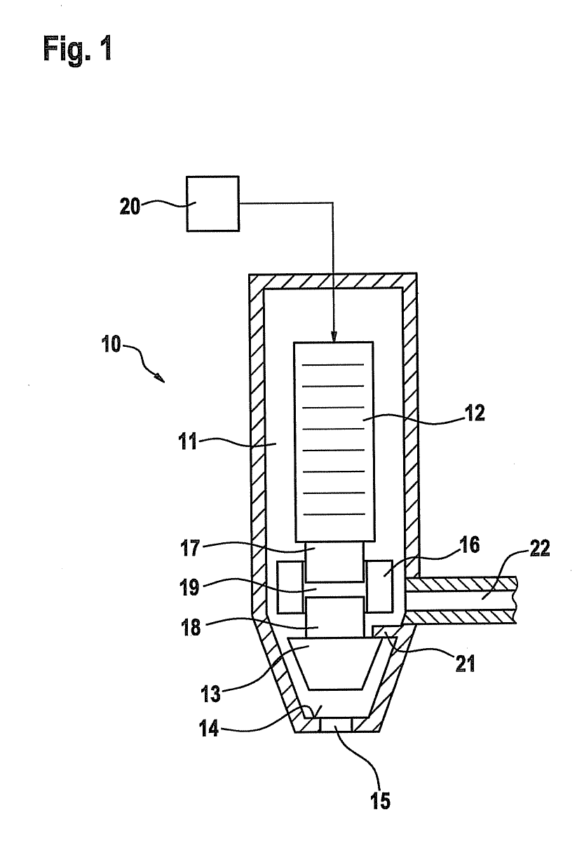

FIG. 1 shows a fuel injector 10 for an internal combustion engine equipped with a piezoelectric actuator 12. Fuel injector 10 is referred to as an injector, which injects fuel 11, e.g., gasoline or diesel, into an intake manifold and/or directly into a combustion chamber of the internal combustion engine. Piezoelectric actuator 12 is triggered by a control unit 20, as indicated by the arrow in FIG. 1. In addition, fuel injector 10 has a nozzle element having a nozzle needle 13, which may sit on a valve seat 14 in the interior of the housing of fuel injector 10. Valve seat 14 surrounds a nozzle opening 15. Injector 10 may of course also have more than one nozzle opening 15, as depicted here. Furthermore, the nozzle openings may also be formed on the side walls of the housing of valve 10.

If nozzle needle 13 is raised by valve seat 14, fuel 11 may flow through nozzle opening 15, so that fuel injector 10 is opened and fuel 11 is injected. This state is depicted in FIG. 1. If valve needle 13 sits on valve seat 14, nozzle opening 15 is closed and no fuel 11 is injected, i.e., fuel injector 10 is closed. In the closed state of injector 10, valve seat 14 forms a stroke stop for nozzle needle 13. A stroke stop for nozzle needle 13 in the open state is labeled with reference numeral 21 in FIG. 1.

The transition from the closed state to the open state is accomplished with piezoelectric actuator 12. To do so, an electric voltage, hereinafter also referred to as trigger voltage U, is applied to actuator 12, inducing a change in length of a piezo stack, which is situated in actuator 12 and is utilized in turn for opening or closing fuel injector 10. In the exemplary embodiment illustrated in FIG. 1, piezoelectric actuator 12 is electrically charged when nozzle opening 15 is closed by nozzle needle 13, i.e., actuator 12 is stretched when injector 10 is closed (so-called inversely operated injector 10). By discharging the piezo stack in actuator 12, its length is reduced and nozzle needle 13 is lifted up from valve seat 14.

Fuel injector 10 also has a hydraulic coupling element. This includes within fuel injector 10 a coupler housing 16, in which two pistons 17, 18 are guided. Piston 17 is connected to actuator 12 and piston 18 is connected to nozzle needle 13. A volume 19 is enclosed between the two pistons 17, 18, accomplishing the transfer of force exerted by actuator 12 to valve needle 13.

Piezoelectric actuator 12 is situated directly above nozzle needle 13 and may be surrounded completely by fuel 11 under pressure. A coating may protect actuator 12 from fuel 11 and ensure electric insulation. The coupling element is surrounded by fuel 11, and volume 19 is also filled with fuel. Volume 19 may adapt to the particular length of actuator 12 over a longer period of time via the guide gaps between two pistons 17, 18 and coupler housing 16. However, volume 19 remains almost unchanged in the case of short-term changes in the length of actuator 12, and the change in length of actuator 12 is transmitted directly to nozzle needle 13 and converted into a corresponding movement. A change in length of piezoelectric actuator 12 also has a direct effect on movement of nozzle needle 13 via the coupling element.

To obtain information about an operating state of fuel injector 10, the method according to example embodiments of the present invention described below is implemented; this method is stored in the form of a computer program in an electronic memory element (not shown), for example, and may be provided in control unit 20 to be processed by a computer unit of control unit 20. However, it is also conceivable for the computer program to be simply kept in reserve on a server of a computer network, e.g., the Internet, for downloading. Interested parties may download the computer program and run it on a computer unit of the control unit. The computer program performs all steps of the method according to example embodiments of the present invention when run on a computer unit of the control unit.

Fuel injector 10 illustrated in FIG. 1 is part of a fuel injection system (common rail system), which may include several injectors 10 by which fuel may be injected into the intake manifold or into the combustion chambers of an internal combustion engine. Either one control unit 20 for all injectors 10 or a separate control unit 20 for each fuel injector 10 may be provided. In addition to injector 10 and control unit 20, the fuel injection system may also include other components, e.g., a fuel reservoir, in particular a high-pressure reservoir rail (common rail) shared by all injectors 10 and connected via a high-pressure fuel line to a connection 22 of fuel injector 10.

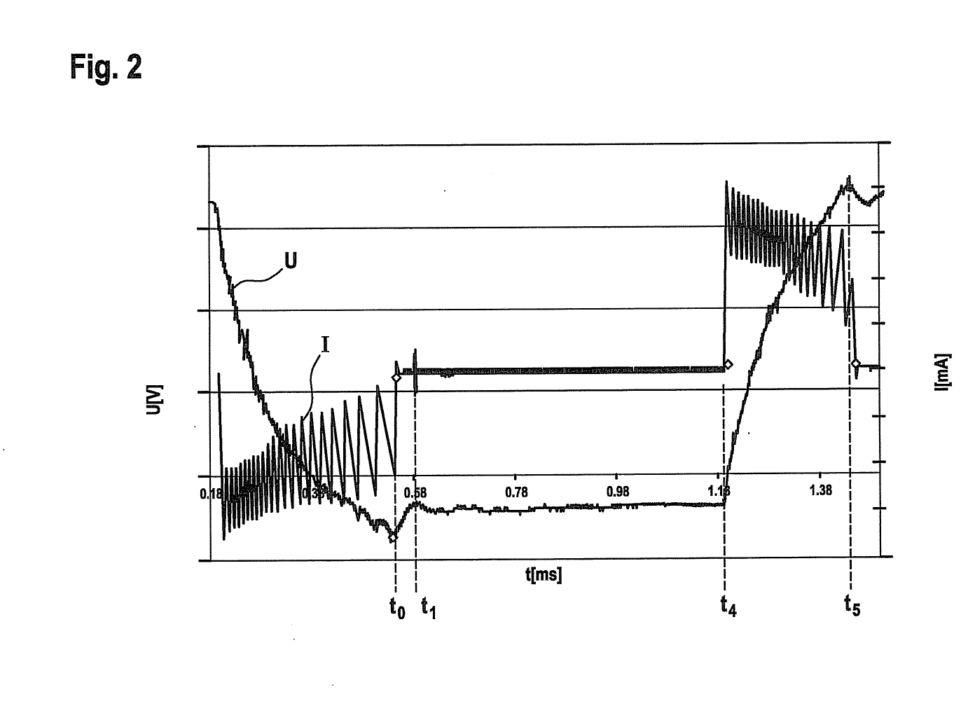

FIGS. 2 through 4 schematically show the time characteristic of trigger voltage U, which is established on actuator 12 when the latter is acted upon by a discharge current I and/or a charging current I to induce opening and subsequent closing of fuel injector 10 and thus cause fuel to be injected. The characteristic of current I is also shown in FIGS. 2 through 4. The sequence of fuel injection is explained in greater detail below with reference to FIG. 2.

Example embodiments of the present invention start with a closed injector 10, whose actuator 12 is charged. Thus an initial voltage Ua is applied to actuator 12 at instant ta. To trigger an injection, piezoelectric actuator 12 is discharged. To do so, actuator 12 is acted upon with a negative discharge current I and applied voltage U drops (start of the discharge operation). With a time lag at the start of the discharge operation, nozzle needle 13 is lifted up from valve seat 14 and at least partially releases at least one nozzle opening 15. Shortly before stroke stop 21 is reached, the energization of actuator 12 stops and actuator 12 is disconnected (end of the discharge operation). At this instant t₀, voltage U has reached its lowest value U₀. Actuator voltage U is thus lowered by voltage ΔU from voltage Uₐ to U₀ in interval tₐ to t₀. Since nozzle needle 13 has not yet reached stroke stop 21 at this instant, it moves further in the previous direction because of inertia, so that the pressure in coupling space 19 of the hydraulic coupler rises again. Because of the piezoelectric effect, this results in an increase in actuator terminal voltage U. As soon as nozzle needle 13 has reached stroke stop 21, the pressure in coupling space 19 no longer changes, so that voltage U remains almost constant at value U₁. The break in the voltage characteristic and/or the voltage peaks after reaching the lowest value at the end of the discharge operation, i.e., after instant t₀, correlate with the time at which needle stroke stop 21 is reached and may be assessed and analyzed accordingly.

A corresponding effect also occurs in the opposite direction, i.e., when injector 10 is moved from the open position to the closed position. In the open position of valve 10, piezoelectric actuator 12 is discharged and a relatively low initial voltage U₄ is applied. To terminate an injection, piezoelectric actuator 12 is activated again, i.e., is acted upon with a positive discharge current I, so that applied voltage U increases (start of the charging operation at instant t₄). With a time lag at the start of the charging operation, nozzle needle 13 is lowered in the direction of valve seat 14, which functions as a stroke stop. Before reaching valve seat 14, the energization of actuator 12 may be terminated and actuator 12 is disconnected (end of the charging operation). Voltage U has reached its highest value at this instant t₅. Nozzle needle 13 moves further due to inertia after the end of energization, so that the pressure in coupling space 19 of the hydraulic coupler drops. Because of the piezoelectric effect, this ensures a drop in actuator terminal voltage U. As soon as nozzle needle 13 is in tight contact with stroke stop 14, the pressure in coupling space 19 and thus also actuator voltage U remain almost constant. The break in the voltage and/or the voltage minimums after reaching the highest value at the end of the charging operation thus correlate with the time at which the needle stroke stop (of valve seat 14) is reached and may be assessed and analyzed accordingly.

According to example embodiments of the present invention the characteristic of actuator terminal voltage U may give an indication that a stroke stop 14, 21 has been reached by suitable assessment and analysis, in particular when actuator 12 is not energized, i.e., fuel injector 10 is left to itself, so to speak. A number of possibilities are conceivable for analyzing voltage signal U applied to the piezoelectric actuator. One possibility is to assess the oscillations of voltage signal U in the energization pauses and to draw, through suitable analysis, inferences about whether stroke stop 14, 21 has been reached. Another possibility that is used to ascertain the instant at which the stroke stop is reached is to ascertain the point of intersection of two equalizing functions, in particular two mean straight lines drawn through the characteristic of voltage signal U and to use them as the instant at which the stroke stop is reached. A simplification may be taken into account here in which the ascending line always has the same slope dU, namely U4−U0 and/or U1−U0.

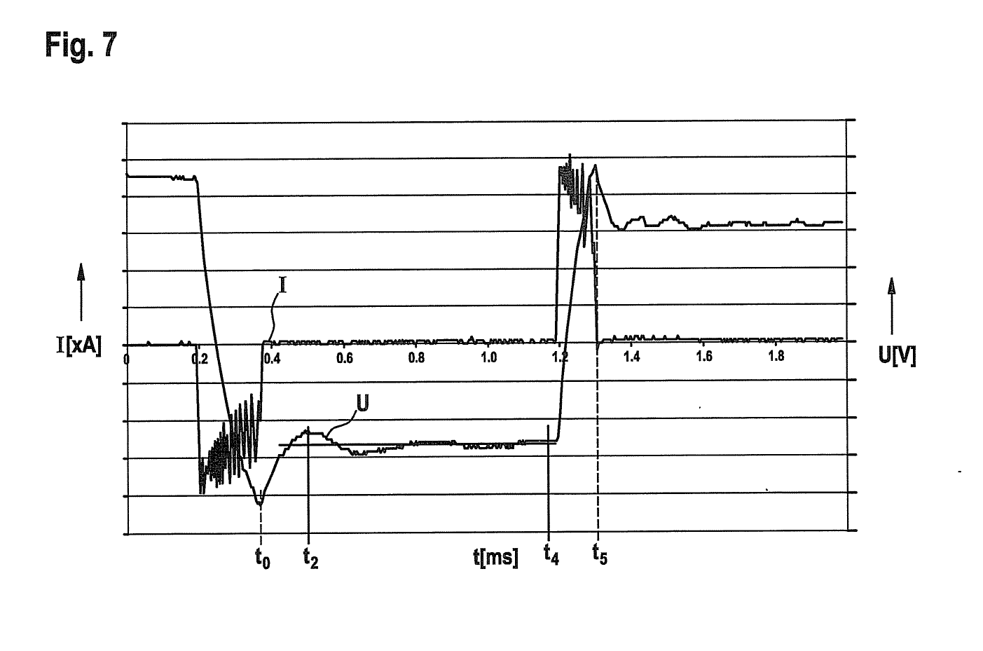

According to a first proposed method, voltage signal U is sampled between end of discharge t0 and start of charging t4 and/or between end of charging t5 and the start of discharge. A regression function, preferably a regression line, is drawn through an interval of sampling values of voltage signal U and a correlation value R of the regression function to the sampling values is ascertained. Whether a needle stroke stop has been reached is detected on the basis of the correlation value (e.g., from t1 to t4 in FIG. 2 or from t2 to t4 in FIG. 7). The regression line is also referred to as a correlation line.

To calculate the regression lines, an optimization problem must be solved in that the position, arbitrary at first, of a straight line (y=a+b·x) through the sampled points of voltage characteristic U must be optimized, so that the distances of the straight lines from the single point become as small as possible (minimization of the sum of squares of the residues). This method is also known as the method of least squares.

$$RSS = {SS}_{Res} = {\sum }_{i = 1}^{n} {e}_{i}^{2} = {\sum }_{i = 1}^{n} {( {y}_{i} - ( a + b \cdot {x}_{i} ) )}^{2} \to min !$$

By partial differentiation and equating the first-order derivatives with zero, a system of normal equations is obtained. The regression coefficients being sought are the solutions

$$b = \frac{\frac{1}{n} {\sum }_{i = 1}^{n} ( {x}_{i} - \overline{x} ) ( {y}_{i} - \overline{y} )}{\frac{1}{n} {\sum }_{i = 1}^{n} {( {x}_{i} - \overline{x} )}^{2}} = \frac{{SS}_{xy}}{{SS}_{xx}}$$

$$and$$

$$a = \overline{y} - b \cdot \overline{x}$$

where x̅ is the arithmetic mean of the x values and y̅ is the arithmetic mean of the y values. SS_{xy} denotes the empirical variance of xᵢ. This estimate is also known as the least squares estimate (LS) or ordinary least squares estimate (OLS).

Correlation value R or the correlation coefficient is a dimensionless measure of the degree of linear correlation between two features. It may assume values only between −1 and +1. At a value of +1 (or −1), there is a complete positive (or negative) linear correlation between the features in question. If the correlation value assumes a value of 0, there is no linear correlation at all between the two features. However, they may nevertheless depend on one another in a nonlinear fashion. In the present exemplary embodiment, the linear correlation between the sampled points of voltage characteristic U and the regression function and/or regression lines drawn through the sampled points is ascertained via the correlation value. If the sampled points of voltage characteristic U are denoted by x₁, x₂, . . . , xₙ and the discrete points of the regression function are denoted as y₁, y₂, . . . , yₙ, the empirical correlation coefficient is calculated according to the following equation

$${Kor}_{e} ( X , Y ) := {ρ}_{e} ( X , Y ) := \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} \cdot \sqrt{{\sum }_{i = 1}^{n} {( {y}_{i} - \overline{y} )}^{2}}}}$$

$$wherein$$

$$\overline{x} = \frac{1}{n} \cdot {\sum }_{i = 1}^{n} {x}_{i} and \overline{y} = \frac{1}{n} {\sum }_{i = 1}^{n} {y}_{i}$$

are expected empirical values X and Y on the basis of the series of points.

In advance of detecting whether nozzle needle 13 has reached a stroke stop 14, 21, a limiting value for correlation value R is determined as a function of the type of injector used. The limiting value may be ascertained empirically, i.e., experimentally, mathematically, or by simulation. The limiting value is selected so there is a high probability that stroke stop 14, 21 has been reached when the correlation coefficient is equal to or greater than the limiting value and/or there is a high probability that stroke stop 14, 21 has not been reached when the correlation coefficient is below the limiting value. The ascertained correlation value, i.e., the absolute value of the correlation value, for instantaneous voltage characteristic U is compared with the limiting value ascertained at the beginning as a function of the type of injector used during the running time of the method, and a needle stroke stop is detected if the ascertained correlation value is greater than or equal to the limiting value.

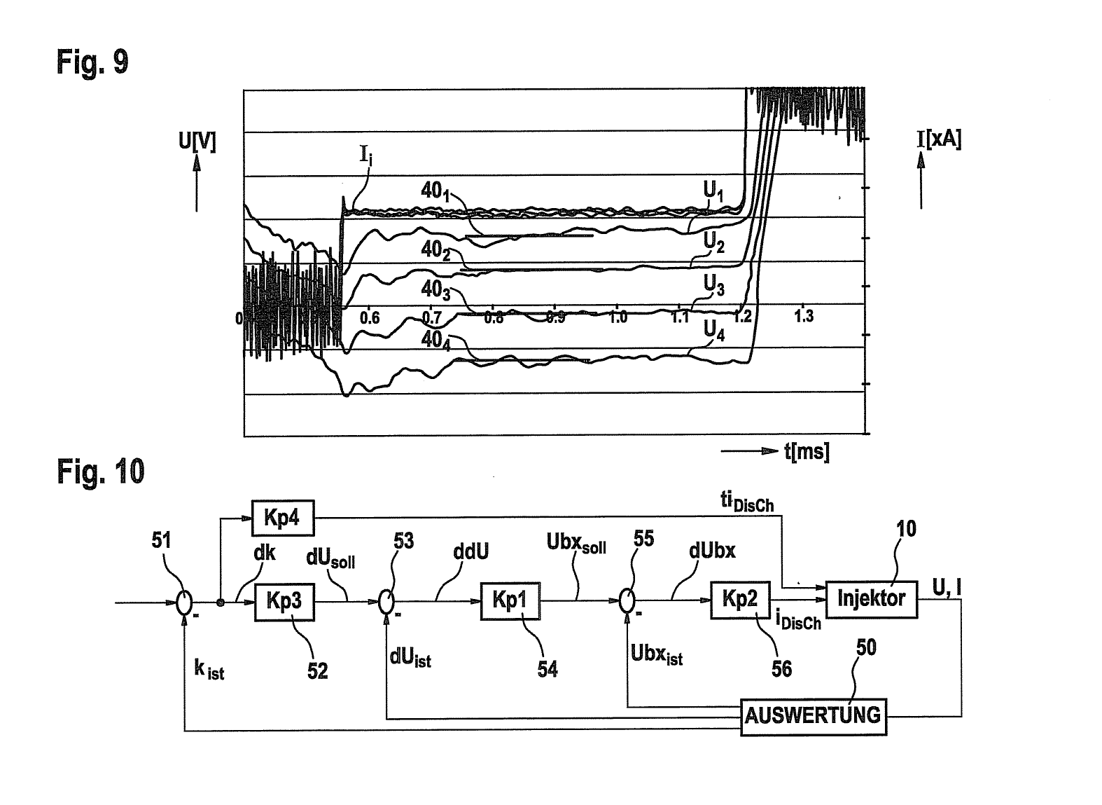

If actuator 12 executes a stroke h that is too small to pull needle 13 to its stroke stop 14, 21 because of stroke loss over the running time or because trigger voltage U is too low, needle 13 oscillates around it subsequent resting position after the end of its movement. This oscillation around the resting position generates an oscillation in trigger voltage U with a similar frequency over the entire high-pressure range. Because of this fixed frequency, a characteristic oscillation valley always occurs at similar times within a triggering operation. To assess whether needle stroke stop 14, 21 has been reached, sum k of the square deviations from a voltage mean 40 (see FIG. 9) is used in the range of the oscillation valley. This sum thus yields a large value when stop 14, 21 has not been reached, because in this case many points have a great deviation from mean 40. If stroke stop 14, 21 is reached, the oscillation frequency changes and multiple oscillation periods having a small amplitude are run through in the range in which there was still an oscillation valley in the case in which stroke stop 14, 21 was not reached. In this case, far fewer points also deviate from mean 40 by a smaller value. Sum k then changes its value, whereupon the change in sum k may be used for detecting that a stroke stop 14, 21 has been reached.

If the sampling values of voltage characteristic U are labeled as Ui and voltage mean 40 is labeled as Ū, sum k of the square deviations from a voltage mean 40 is obtained with the following equation:

$$k = \frac{1}{n} {\sum }_{i = 1}^{n} {( {U}_{i} - \overline{U} )}^{2}$$

This exemplary embodiment is depicted in FIG. 9. This figure shows four different voltage characteristics U, a relatively large number of points deviating a relatively great distance from mean 40₁ in voltage characteristic U₁. It is therefore possible to infer that needle 13 has not reached stroke stop 14, 21. Relatively few points in voltage characteristics U₂, U₃, U₄ deviate from means 40₂, 40₃, 40₄ and/or the points deviate by a relatively small amount. It is therefore possible to conclude that needle 13 has reached stroke stop 14, 21.

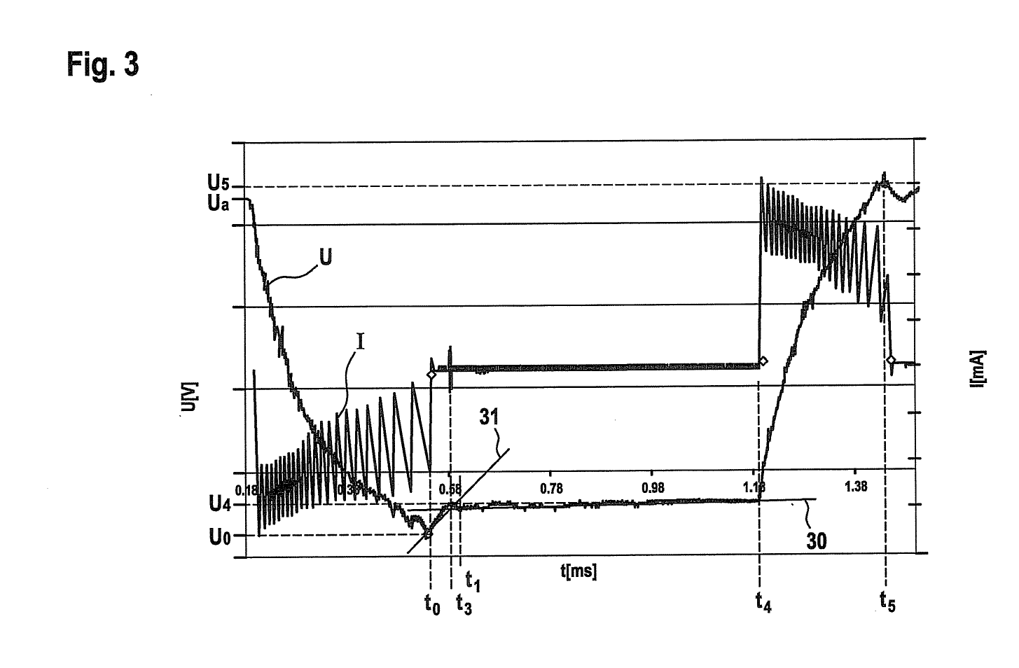

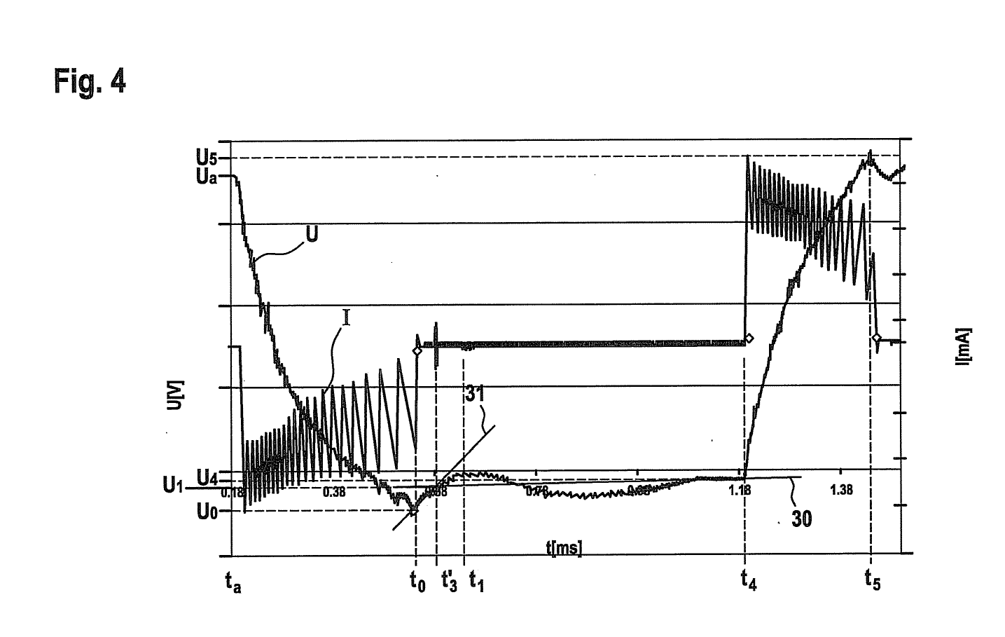

FIGS. 3 and 4 show a regression line 30 through an interval of multiple sampled points of voltage characteristic U between end of discharging t0 and start of charging t₄. In the example from FIG. 3, regression line 30 was drawn through sampled points of voltage characteristic U between points in time t₃ and t₄. Voltage characteristic U from FIG. 3 belongs to a fuel injector 10, which has reached stroke stop 21, and voltage characteristic U from FIG. 4 belongs to a fuel injector 10, which has not reached stroke stop 21. Since regression line 30 in FIG. 3 covers the measurement much better than regression line 30 in FIG. 4, there is a much larger correlation value R for regression line 30 from FIG. 3 than for line 30 from FIG. 4. By selecting a suitable limiting value and comparing correlation value R with the limiting value, it is possible to detect reliably and with certainty whether stroke stop 14, 21 has been reached.

Before ascertaining the regression lines and/or the correlation value, voltage characteristic U may be smoothed, i.e., filtered, by, for example, forming a mean over a certain number of sampling values, e.g., over five sampling values.

Only after stroke stop 14, 21 is reached is fuel injector 10 completely closed or open. The exact instant at which stroke stop 14, 21 is reached is thus of great importance in regulating the quantity of fuel to be injected. For example, if stroke stop 14, 21 is reached too late or not at all, it is possible to intervene through regulation so that the predefined amount of fuel is nevertheless injected within a predefined period of time. In this manner, drifts in quantity due to old or worn fuel injectors 10 or those subject to a manufacturing tolerance may be regulated out.

According to an example embodiment, the first-order derivative of voltage characteristic U is formed. This may be done on the basis of analog voltage signal U or on the basis of discrete sampling values of voltage signal U. Instant t₁ in FIG. 2, at which the derivative assumes value 0 for the first time, is used to divide voltage characteristic U into two ranges, a rising range between t₀ and t₁ and a plateau range between t₁ and t₄. In these two ranges, a regression function 30, 31, preferably a regression line, is drawn through sampled points of voltage characteristic U. The point of intersection of these two regression functions 30, 31 is used as the instant (t₃ in FIG. 3 for an intact injector 10 and t₃′ in FIG. 4 for an injector 10 that is not intact) at which nozzle needle 13 has reached stroke stop 21. The fact that t₃′ is greater than t₃ means that needle 13 has reached stroke stop 21 in FIG. 4 too late.

The correlation factor may also be used here as a criterion for whether needle 13 has actually reached stop 21. As explained above, voltage U has a flat characteristic in the plateau region when needle 13 is in contact with stop 21, and the correlation factor thus has a relatively high value (see FIG. 3). If needle 13 does not reach stop 21, voltage U in the plateau region has a waviness and the correlation factor has a much lower value (see FIG. 4).

Again in this example embodiment, before forming the first-order derivative and/or before ascertaining the regression lines and/or the correlation value, voltage characteristic U may be smoothed, i.e., filtered, by, for example, forming a mean over a certain number of sampling values, e.g., over five sampling values.

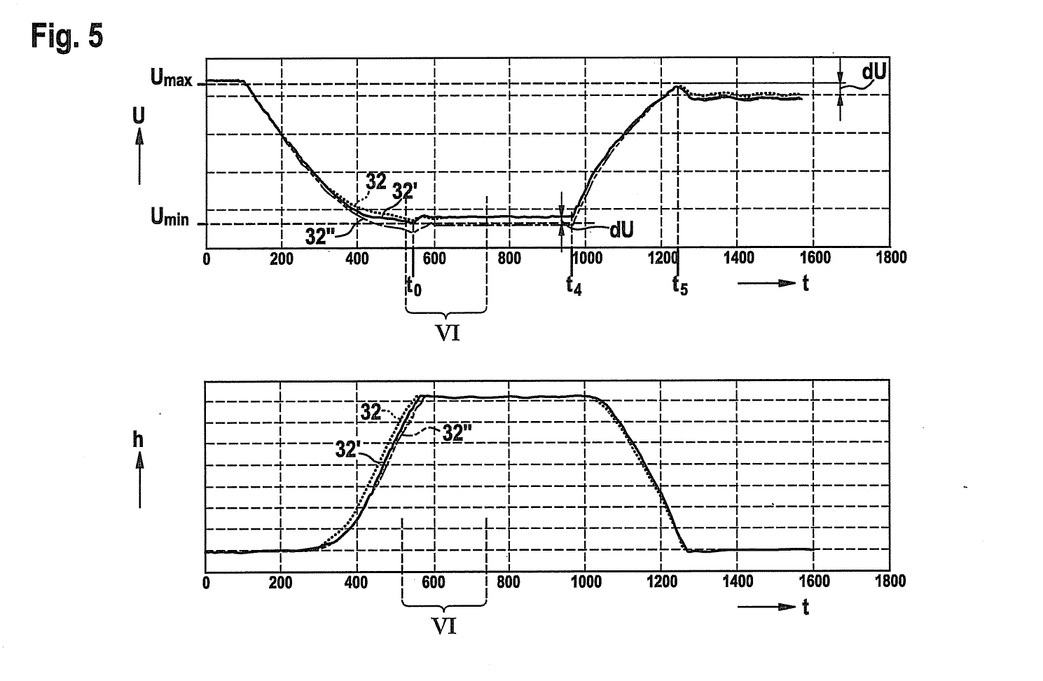

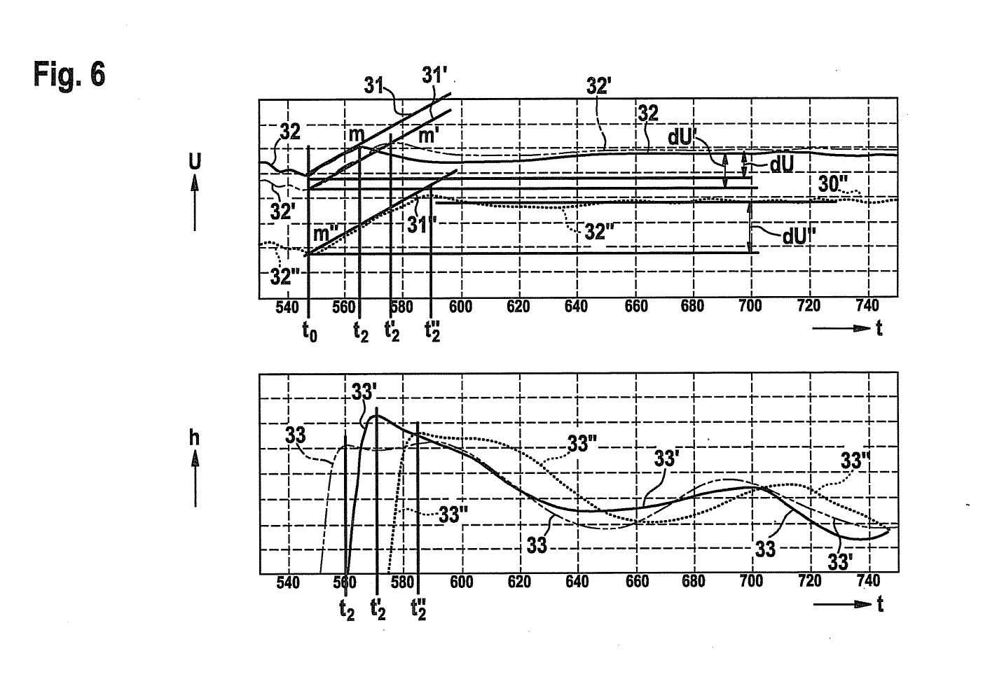

In FIGS. 5 and 6, a voltage characteristic U is plotted at the top, and at the bottom a corresponding stroke characteristic h of nozzle needle 13 is plotted as a function of time t. Voltage characteristic U shown in FIG. 5 corresponds qualitatively to the characteristic of voltage U from FIGS. 2 through 4. FIG. 6 shows a detail VI of the voltage characteristic and stroke characteristic from FIG. 5. Voltage characteristic U shown in FIGS. 5 and 6 comes about as follows:

As of t=100 μs, actuator 12 is discharged, starting from starting voltage U=170 V. Actuator 12 contracts and thereby lowers the pressure in coupling space 19, which results in the opening of nozzle needle 13. At t₀ (see top of FIG. 6), the energization stops and actuator 12 is disconnected, i.e., is left to itself. Since needle 13 has not yet reached stroke stop 21, it continues to move (see FIG. 6, bottom) so that the pressure in coupling space 19 rises again. This ensures an increase in actuator terminal voltage U via the piezoelectric effect. As soon as needle 13 has reached stroke stop 21 (instant t₂ in FIG. 6 for a new injector), the pressure in coupling space 19 no longer changes, so that voltage U remains almost constant.

Reference numeral 32 in FIGS. 5 and 6 denotes voltage characteristic U and reference numeral 33 denotes stroke characteristic h of a new injector 10. Reference numeral 32′ in FIGS. 5 and 6 denotes voltage characteristic U and reference numeral 33′ denotes voltage characteristic h of an old injector 10′ (stroke stop 21 is reached later, if at all). Reference numeral 32″ in FIGS. 5 and 6 denotes voltage characteristic U and reference numeral 33″ denotes stroke characteristic h of an injector 10″ having a worn nozzle element. The break in voltage and/or the voltage extremes (maximums or minimums) at t₂, t₂′, t₂″ thus correlate with the time at which needle stroke stop 21 is reached.

When closing injector 10, the same physical effect applies: needle 13 continues to move after the end of energization so that the pressure in coupling space 19 increases, which results in a declining actuator terminal voltage U. As soon as needle 13 rests on valve seat 14, the pressure in coupling space 19 and thus also actuator voltage U remain substantially constant.

To determine whether stroke stop 21 and/or 14 has been reached, the first voltage value of voltage signal U is ascertained around the expected voltage maximum at instant t₁ (see FIG. 2) or at instants t₂, t₂′, t₂″ (see FIG. 6) or around the voltage minimum after the end of discharging at instant t5 (see FIGS. 3 and 4), and another voltage value is ascertained before the start of charging at instant t₄ (see FIG. 6) and/or before the start of discharging. If the measured first voltage is much greater than the additional voltage measured shortly before instant t₄, this indicates that stroke stop 21 has not been reached. If the measured first voltage is much lower than the additional voltage measured before instant t₄, this indicates that nozzle needle 13 has been pulled too strongly against needle stroke stop 21: a great vacuum in coupling space 19 ensures that fuel 11 is resupplied through leakage gaps, so that the pressure increases and thus actuator voltage U also increases due to the piezoelectric effect. Here again, the particular voltage limiting values must be ascertained in a manner specific for the type of injector.

Alternatively, the transition of the voltage characteristic from the rising range to the plateau range may also be ascertained via the derivative of voltage characteristic U and the zero crossing of the derivative. A first voltage value is ascertained at instant t0 (see FIG. 6) at the end of the discharge operation and at the start of the energization pause, and another voltage value is ascertained at instant t₁ (see FIG. 2) and/or at instants t₂, t₂′, t₂″ (see FIG. 6) of the zero crossing of the derivative of the voltage characteristic. On the basis of these two voltage values and/or on the basis of difference dU in the two voltage values, the instant at which the stroke stop is reached may also be ascertained. The regulator may thus regulate to this dU as well as to the dU described in the next section. The idea is to use the dU described here for ascertaining the instant at which the stroke stop is reached. If the difference between the first measured voltage value and the additional voltage value is very great, it may be assumed that the stroke stop has not been reached at all or has been reached too late. If the difference is very small, it may be assumed that needle 13 has been run too strongly against the stroke stop. Corresponding limiting values for the voltage values or the difference, which are specific for the given type of injector, may be ascertained in advance and used during the running time of the method to ascertain a stroke stop and/or to ascertain the instant of a stroke stop.

To be able to determine the exact instant at which stroke stop 14, 21 is reached in a particularly simple manner, a simplification is utilized, namely that slope m is almost constant in the rising range of voltage U over the entire rising range and for various voltage characteristics U over the lifetime of injector 10 (see top of FIG. 6) and therefore may be ascertained rapidly, unambiguously and in an uncomplicated manner and may be taken into account in all following calculations of the instant at which the stroke stop is reached. The instant of the needle stroke stop which is being sought may then be calculated by ascertaining voltage difference dU between the shutdown voltage (which is known accurately in time; instant t₀) and the stabilized final voltage in the opened injector state before instant t₄ and the time difference between shutdown instant t₀ and the reaching of stroke stop 21 is calculated via known slope m. This may be performed much more easily than searching for a break between the rising range and the plateau range in the course of voltage U. The constant correlation between voltage difference dU and the instant at which the stroke stop is reached after the end of energization at instant t₀ may be stored in a table so that the slope no longer needs to be taken into account during the running time of the method.

The following example shall be explained here. For example, if m=300,000 V/s is obtained as the slope and a voltage difference dU=2 V is obtained in voltage characteristic U of an injector 10, the instant at which stroke stop 14, 21 is reached may be calculated using the following equation:

$$t = \frac{d U}{m} = \frac{1 s \cdot 2 V}{300.000 V} = 6 , 667 µs$$

This means that stroke stop 14, 21 is reached at t=6667 μs after instant t0 at which the current is shut down. This correlation may be calculated for many other voltage differences for the type of injector in question and the results may be stored in a table.

If a higher-level regulation is used to regulate difference dU (regardless of how calculated) to a desired value, minor changes in slope m, e.g., changes due to a change in actuator capacitance, result only in negligible errors in the ascertained stop time. If voltage difference dU is selected to be too great, the stroke stop is not reached. If difference dU is selected to be too small, needle 13 strikes too strongly against stroke stop 14, 21. If difference dU is selected to be small enough without being too large or too small, stroke stop 14, 21 is reached reliably and with certainty without moving too sharply against the stop.

In the proposed method the injection time and the maximum injection rate are known (apart from nozzle coking), so that the quantity of fuel injected may be adjusted with high precision. By varying discharge current I, which flows through actuator 12, stroke h of nozzle needle 13 may be increased so that stroke stop 14, 21 is usually reached. In the second exemplary embodiment, for detecting whether stroke stop 14, 21 is reached, slope m of the rising range of trigger voltage U of actuator 12 is not the important factor, but instead only voltage difference dU is important.

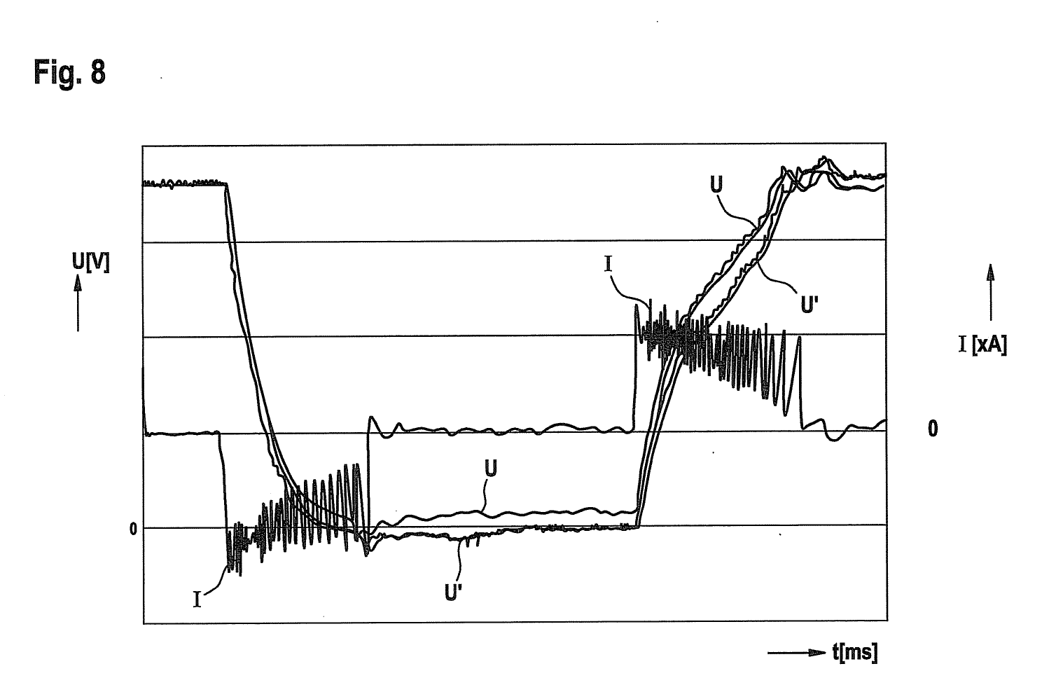

If an injection is to take place using an inversely operated fuel injector 10, actuator 12 of closed injector 10 is discharged and actuator 12 contracts and creates a vacuum in coupling space 19 above needle 13, thereby setting needle 13 in motion. If needle 13 has just lifted up from its seat 14, fuel 11, which is under a high pressure, may act beneath seat 14 and accelerate needle 13 upward. Due to this upward movement, first the vacuum in coupling space 19 is dissipated and then an excess pressure is created. This excess pressure creates a force acting on actuator 12 by then inducing a positive voltage U because of the piezoelectric effect. In the operating state in which actuator 12 executes an adequate stroke h, the needle movement ends abruptly when nozzle needle 13 reaches its stroke stop 21. Due to the fact that force is no longer acting on actuator 12, trigger voltage 12 remains essentially constant on a plateau. This correlation is depicted in FIG. 8, for example, where voltage characteristic U of an intact injector 10 and voltage characteristic U′ of an injector 10′ are shown, the nozzle needle 13′ of which does not reach valve seat 14. Currents I of these two injectors 10, 10′ are also shown.

If actuator 12 is capable of executing an adequate stroke h to pull needle 13 against its mechanical stop 21, the instant at which the stop is reached may be adjusted by voltage difference dU between the voltage minimum (at instant t₀) and the first local maximum occurring thereafter (at the first zero crossing of the derivative of the voltage characteristic at instant t₁ and/or t₂).

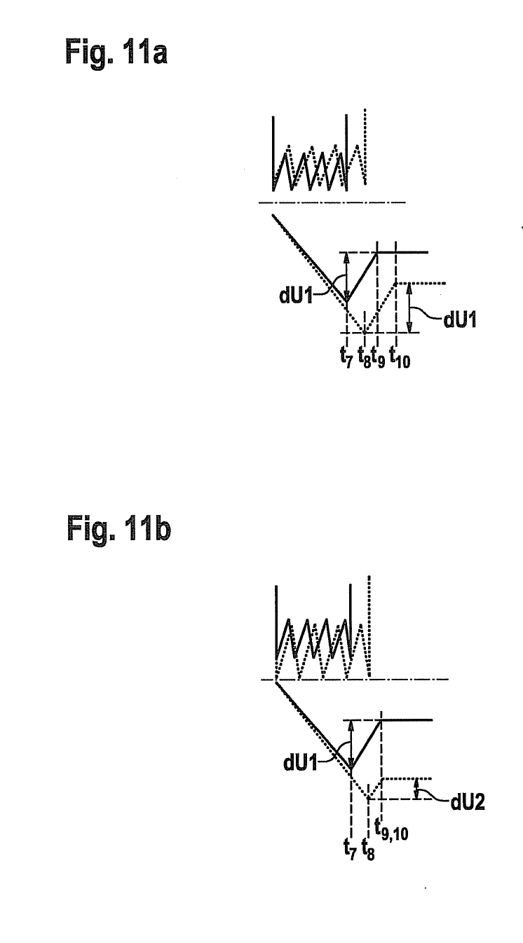

The underlying simplifying assumption for this is that slope m, with which voltage U rises between these two points, is constant (see discussion above). If the analysis of one of the criteria described above (correlation value R or sum k) reveals that needle 13 has not reached its stroke stop 14, 21, the compensation method responds to this by the fact that the discharge time is increased to increase the voltage lift (see FIG. 11). If the setpoint of the dU regulator is now kept constant, needle 13 would reach its stroke stop 14, 21 too late. For this reason, the lengthening of the discharge time must be associated with a change, preferably a reduction, in the setpoint value of the dU regulator. This state of affairs and the functioning are depicted in FIG. 11.

If a reliable stroke stop 14, 21 has occurred over several triggerings, the regulator will attempt to reduce the voltage excursion again. This is necessary so that the regulator may not correct in only one direction and thus is no longer able to correct errors in the event of faulty measurements. To reduce the voltage excursion, precisely the opposite of the procedure described above is followed. The discharge time is thus shortened and dU is increased.

An exemplary regulating structure is explained in greater detail below on the basis of FIG. 10, where several regulating circuits are provided, one inside the other in the manner of a cascade. The outermost regulating circuit regulates sum k of the square deviations of voltage signal U from a voltage mean 40 or correlation coefficient R from the first example or another variable of another method for detecting the stroke stop. Voltage U is detected at injector 10 and after an analysis in a function block 50 according to one or more of the methods described above, actual value k_{actual} (or R_{actual}) is obtained for sum k (and/or correlation coefficient R). The smallest possible value, e.g., zero, is predefined as setpoint value kₛₑₜₚₒᵢₙₜ or Rₛₑₜₚₒᵢₙₜ. In a subtraction block 51, difference dk (and/or dR) of setpoint value ksetpoint (or Rsetpoint) and actual value k_{actual} (or R_{actual}) of sum k of the square deviations from a voltage mean (or the correlation coefficient R) are formed. Difference dk (or dR) is sent as the regulating difference to a regulator 52, e.g., a proportional regulator, using a gain factor Kp3.

The signal variable of regulator 52 of sum k (or of correlation coefficient R) is at the same time the guidance variable (setpoint value dUₛₑₜₚₒᵢₙₜ) of the lower-level regulation of difference dU, which is calculated in the same way as usual. As part of analysis 50 according to one or more of the methods described above, actual value dU_{actual} for difference dU is also ascertained from actuator voltage U applied to injector 10. In a subtraction block 53, difference ddU between setpoint value dUₛₑₜₚₒᵢₙₜ and actual value dU_{actual} is formed. Difference ddU is sent as a regulating difference to a regulator 54, e.g., a proportional regulator having a gain factor Kp1.

The signal variable of regulator 54 of sum k is at the same time the guidance variable (setpoint value Ubxₛₑₜₚₒᵢₙₜ) of the lower-level regulation of voltage Ubx applied to actuator 12, where voltage Ubx corresponds to ΔU described above. Actuator voltage Ubx applied to injector 10 is detected as actual value Ubx_{actual}. In a subtraction block 55, difference dUbx between setpoint value Ubxₛₑₜₚₒᵢₙₜ and actual value Ubx_{actual} of voltage Ubx is formed. Difference dUbx between the voltages is sent as the regulating difference to a regulator 56, e.g., a proportional regulator using a gain factor Kp2.

The signal variable of regulator 56 is discharge current I, the characteristic of which is plotted in the various diagrams and labeled as i_{DisCh} (discharge) in FIG. 10. Injector 10 and/or its piezoelectric actuator 12 is/are acted upon by this discharge current. Difference dk between setpoint value kₛₑₜₚₒᵢₙₜ and actual k_{actual} of sum k of the square deviations from a voltage mean 40 is also sent to a regulator 57, i.e., a proportional regulator having a gain factor Kp4. The signal variable of regulator 57 is discharge time tiDisCh for which injector 10 is acted upon by discharge current i_{DisCh} so that the desired quantity of fuel is injected.

On the basis of FIG. 11, it will be explained in greater detail how the triggering of fuel injector 10 must be corrected so that, first of all, nozzle needle 13 reliably reaches stroke stop 14, 21 and, on the other hand, nozzle needle 13 reaches stroke stop 14, 21 within a desired period of time. The top of FIG. 11a uses a solid line to show the characteristic of trigger current I of actuator 12 in the original uncorrected state. The dotted line shows the characteristic of trigger current I with the discharge time corrected. The bottom of FIG. 11a uses a solid line to show the characteristic of uncorrected actuator voltage U applied to actuator 12. The dotted line is the characteristic of voltage U with a different discharge time. This shows clearly that lengthening the discharge time from the end of discharging at t₇ to the end of discharging at t₈ creates the enlarged voltage excursion, but also results in needle stroke stop 14, 21 being reached later. Stop 14, 21 is not reached until instant t₁₀ instead of at instant t₉.

The top of FIG. 11b uses a solid line to show the characteristic of discharge current I of actuator 12 in the original uncorrected state. The dotted line indicates the characteristic of discharge current I with the corrected discharge time and corrected voltage difference dU. The bottom of FIG. 11b uses a solid line to show the characteristic of uncorrected actuator voltage U applied to actuator 12. The dotted line indicates the characteristic of voltage U with an altered discharge time and altered voltage difference dU (dU2 instead of dU1, where dU2<dU1). This shows clearly that lengthening the discharge time from t₇ to t₈ creates a larger voltage excursion. However, the fact that needle stroke stop 14, 21 from the bottom of FIG. 11a is reached at a later instant is compensated in FIG. 11b by the fact that a smaller value for voltage difference dU is predefined as the setpoint value. As a result, stop 14, 21 is already reached at an instant tₗ₀ which corresponds exactly to original instant t₉. If the voltage excursion is to be reduced, dU2≦dU1 applies as a matter of course, so that despite a shortened discharge time, stroke stop 14, 21 is not reached too early.

1-33. (canceled)

34. A fuel injection system, comprising:
at least one fuel injector; and
a control unit adapted to trigger the injector
wherein each injector includes:
a piezoelectric actuator;
a nozzle element having at least one nozzle opening and at least one movable nozzle needle adapted to selectively open and close the at least one nozzle opening;
a hydraulic coupling element connected between the piezoelectric actuator and the nozzle needle; and
at least one stroke stop against which the nozzle needle rests in at least one of (a) a completely open and (b) a completely closed position; and
wherein the control unit includes a detection device adapted to detect a stop of the nozzle needle on the at least one stroke stop, the detection device adapted to detect the needle stroke stop during an energization pause of the piezoelectric actuator on the basis of a characteristic of a voltage signal applied to the piezoelectric actuator.

35. The fuel injection system according to claim 34, wherein the detection device is adapted to assess an oscillation amplitude of the voltage signal at least one of (a) between an end of discharging and a start of charging and (b) between an end of charging and a start of discharging.

36. The fuel injection system according to claim 35, wherein the detection device is adapted to sample the voltage signal at least one of (a) between the end of discharging and the start of charging and (b) between the end of charging and the start of discharging, draw at least one of (a) a regression function and (b) a regression line through an interval of sampling values of the voltage signal and ascertain a correlation value to the sampling values, detecting on the basis of a size of a correlation value whether there is a needle stroke stop.

37. The fuel injection system according to claim 36, wherein the detection device is adapted to compare the ascertained correlation values with a limiting value ascertained in advance as a function of a type of injector used and detect a needle stroke stop if the ascertained correlation value is greater than or equal to the limiting value.

38. The fuel injection system according to claim 34, wherein the detection device is adapted to ascertain a first voltage value of the voltage signal at a beginning of the energization pause and another voltage value of the voltage signal at a later instant during the energization pause, detecting whether or not there is a needle stroke stop on the basis of a difference between the first voltage value and the additional voltage value.

39. The fuel injection system according to claim 38, wherein an instant at the beginning of the energization pause at which the first voltage value is ascertained is at least one of (a) at or after an end of discharging and (b) at or after an end of charging.

40. The fuel injection system according to claim 38, wherein an instant at the beginning of the energization pause at which the first voltage value is ascertained is at an instant at which a derivative of the voltage characteristic has a first zero crossing.

41. The fuel injection system according to claim 38, wherein the later instant at which the additional voltage value is ascertained is at least one of (a) shortly before a start of charging and (b) shortly before a start of discharging.

42. The fuel injection system according to claim 39, wherein the later instant at which the additional voltage value is ascertained is at an instant at which a derivative of the voltage characteristic has a first zero crossing.

43. The fuel injection system according to claim 41, wherein the detection device is adapted to compare the ascertained voltage difference with a limiting value ascertained in advance as a function of a type of injector used, and to detect a failure to reach a needle stroke stop if the first voltage value at the beginning of the energization pause is greater than the additional voltage value at a later instant, and a value of the ascertained voltage difference is greater than or equal to the limiting value.

44. The fuel injection system according to claim 41, wherein the detection device is adapted to compare the ascertained voltage difference with a limiting value ascertained in advance as a function of a type of injector used, and to detect that the nozzle needle was pulled too strongly against a stroke stop if the first voltage value at the beginning of the energization pause is smaller than the additional voltage value at a later instant and the value of the ascertained voltage difference is greater than or equal to the limiting value.

45. The fuel injection system according to claim 35, wherein the detection is adapted to consider the voltage signal during the energization pause, subdivide the characteristic of the voltage signal in a considered range into a rising range and a subsequent plateau range, form a voltage mean through the plateau range and ascertain a sum of square deviations of the voltage signal from the voltage mean (in the plateau range, detecting on the basis of a size of the ascertained sum whether there is a needle stroke stop.

46. The fuel injection system according to claim 45, wherein the detection is adapted to compare the ascertained sum with a limiting value ascertained in advance as a function of a type of injector used and detect a needle stroke stop if the ascertained sum is less than or equal to the limiting value.

47. The fuel injection system according to claim 34, wherein the detection is adapted to form a first derivative over the voltage signal during an energization pause, use an instant at which the derivative has a zero crossing for a first time to subdivide the characteristic of the voltage signal into a rising range and a plateau range, draw at least one of (a) a regression function and (b) a regression line, through the voltage signal in the rising range and in the plateau range and use a point of intersection of two regression functions as an instant at which there is a needle stroke stop.

48. The fuel injection system according to claim 34, wherein the detection is adapted to determine an instant of the needle stroke stop only when it has first been ascertained that there is a needle stroke stop at all.

49. A method for ascertaining a needle stroke stop in a fuel injector, comprising including a piezoelectric actuator, a nozzle element having at least one nozzle opening and at least one movable nozzle needle for selectively opening and closing the at least one nozzle opening, a hydraulic coupling element connected between the piezoelectric actuator and the nozzle needle, and at least one stroke stop against which the nozzle needle rests in at least one of (a) a completely opened and (b) a completely closed position, comprising:
ascertaining the at least one stroke stop by analyzing a characteristic of a voltage signal applied to the piezoelectric actuator during an energization pause of the piezoelectric actuator.

50. The method according to claim 49, wherein an oscillation amplitude of the voltage signal at least one of (a) between an end of discharging and a beginning of charging and (b) between an end of charging and a beginning of discharging is assessed.

51. The method according to claim 50, wherein at least one of (a) a regression function and (b) a regression line is drawn through the voltage signal applied to the piezoelectric actuator during the energization pause and the at least one needle stroke stop is ascertained by analyzing a characteristic of the at least one regression function.

52. The method according to claim 51, wherein a first derivative of the voltage signal is formed during the energization pause, an instant at which the derivative has a first zero crossing is used for subdividing the characteristic of the voltage signal into a rising range and a plateau range, at least one of (a) a regression function and (b) a regression line is drawn through the voltage signal in the rising range and in the plateau range and a point of intersection of the two regression functions is used as the instant of the needle stroke stop.

53. The method according to claim 51, wherein at least one of (a) a regression function and (b) a regression line is drawn through an interval of the voltage signal during the energization pause and a correlation value to the voltage signal is ascertained, the needle stroke stop being detected on the basis of a size of the correlation value.

54. The method according to claim 52, wherein the voltage signal is sampled at least one of (a) before forming the derivative and (b) before ascertaining the regression function, and further processing of the voltage signal is performed on the basis of sampling values.

55. The method according to claim 53, wherein the ascertained correlation values are compared with a limiting value ascertained in advance as a function of a type of injector used and a needle stroke stop is detected if the ascertained correlation value is greater than or equal to the limiting value.

56. The method according to claim 50, wherein the voltage signal is considered during the energization pause, the characteristic of the voltage signal is subdivided in a considered range into a rising range and a subsequent plateau range, a voltage mean being formed in the plateau range, a sum of values of weighted deviations of the voltage signal from the voltage mean in the plateau range is ascertained, and a needle stroke stop is detected on the basis of a size of the ascertained sum.

57. The method according to claim 56, wherein a sum of the square deviations of the voltage signal from the voltage mean is ascertained in the plateau range.

58. The method according to claim 56, wherein the ascertained sum is compared with a limiting value ascertained in advance as a function of the type of injector used and a needle stroke stop is detected if the sum ascertained is less than or equal to the limiting value.

59. The method according to claim 49, wherein a first voltage value of the voltage signal is ascertained at a beginning of an energization phase and another voltage value of the voltage signal is ascertained at a later instant during the energization pause, a difference between the first voltage value and the additional voltage value being used to detect whether there is a needle stroke stop.

60. The method according to claim 59, wherein an instant at the beginning of the energization pause at which the first voltage value is ascertained is at least one of (a) at or after an end of discharge and (b) at or after an end of discharge.

61. The method according to claim 59, wherein the instant at the beginning of the energization pause at which the first voltage value is ascertained is at an instant at which a derivative of the voltage characteristic has a first zero crossing.

62. The method according to claim 59, wherein the later instant at which the additional voltage value is ascertained is at least one of (a) shortly before a start of charging and (b) shortly before a start of discharging.

63. The method according to claim 60, wherein the later instant at which the additional voltage value is ascertained is at an instant at which a derivative of the voltage characteristic has a first zero crossing.

64. The method according to claim 61, wherein the ascertained voltage difference is compared with a limiting value ascertained in advance as a function of the type of injector used, and failure to reach a needle stroke stop is detected if the first voltage value at the start of the energization pause is greater than the additional voltage value at the later instant and the value of the ascertained voltage difference is greater than or equal to the limiting value.

65. The method according to claim 61, wherein the ascertained voltage difference is compared with a limiting value ascertained in advance as a function of the type of injector used and it is detected that the nozzle needle has been pulled too strongly against a stroke stop if the first voltage value at the start of the energization pause is less than the additional voltage value at a later instant and the value of the ascertained voltage difference is greater than or equal to the limiting value.

66. The method according to claim 49, wherein the method is implemented as a computer program which is capable of execution on a control unit for triggering a fuel injector using a piezoelectric actuator.
